(19) United States
(12) Patent Application Publication
(10) Pub. No.: US 2021/0221726 A1
(43) Pub. Date: Jul. 22, 2021

(54) PROCEDURE FOR PROVIDING AND IMPROVING PUMPABILITY OF HIGH TO VERY HIGH BIOSOLIDS CONTAINING DEWATERED SOLID SEWAGE SLUDGE

(71) Applicant: Lystek International Corp., Cambridge (CA)

(72) Inventor: Owen Patrick Ward, Waterloo (CA)

(73) Assignee: Lystek International Corp., Cambridge, ON (CA)

(21) Appl. No.: 17/045,781

(22) PCT Filed: Apr. 9, 2019
(86) PCT No.: PCT/CA2019/050427

§ 371 Date: Oct. 7, 2020

(30) Foreign Application Priority Data
Apr. 9, 2018 (GB) 1805887.5

(51) Int. Cl. C02F 11/13; C02F 11/145; C05F 7/00

(52) U.S. Cl. CPC C02F 11/13; C02F 11/131; C05F 7/00; C02F 11/145

(57) ABSTRACT

The invention provides a process for the drying and re-hydration of high solids Biosolids cake to be converted into a pumpable organic liquid fertilizer. This process may be carried out at ambient pressure without aggressive shearing of the mixture of added process water and the high solids Biosolids cake. The drying step removes the bound water, while the re-hydration step includes mixing which breaks down the particulate matter to produce a fairly homogeneous suspension.

### FIELD OF THE INVENTION

This invention relates to the processing of high solids Biosolids Cake into pumpable liquid organic fertilizers, and resulting improved organic fertilizers.

### BACKGROUND

Raw sewage is a mix of water and wastes from domestic, commercial and industrial life that are flushed into the sewer. These wastes include both biologically and inorganically derived solids, semi-solids, semi-liquids and liquids, including water.

Raw sewage is treated to retrieve water that the waste process and sewering put into it. This is often conducted in treatment plants (with 1 or more stages) whereby sewage is digested, and then water is separated and cleaned so that it may be safely treated and discharged as effluent. The solids management side of the overall wastewater treatment process often includes a mechanical or chemical/mechanical de-watering step.

Once the water is removed to one degree or another, the remainder from the process is herein termed ‘sewage sludge’. This sewage sludge is often a dry cake-like material having many of the characteristics of a solid or semi-solid. In this application the word solid applies to materials which do not flow under gravitational forces and ambient temperatures or are essentially not pumpable within routine industrial processing requirements, as herein provided. In this application solid sewage sludge is referred to as “Biosolids Cake” or just “Cake” or by the acronym ‘BSC’.

BSC is the result of de-watering to reduce the volume of digested or undigested raw sewage and thereby reduce the consequent transport complications of dealing with the high volume of and the cost of further processing of sewage waste. Without dewatering such waste originally includes as much as 95-97% water, a 3-5% Biosolids component, and often unwanted and/or other dangerous components.

For the purposes of this patent application, biosolids cake is understood that it could also include some undigested de-watered raw sewage.

The biosolids cake is a sticky solid with little or no slump. biosolids cake has many gel-like characteristics and is only readily transported or used as a solid mass. Even this has challenges as it is and remains sticky and difficult to work with.

This biosolids cake can then be further treated or processed into a useful biosolids material referred to by the USEPA as, “The (biosolids) are nutrient-rich organic materials resulting from the treatment of domestic sewage in a treatment facility. When treated and processed, these residuals can be recycled and applied as fertilizer to improve and maintain productive soils and stimulate plant growth.”

Biosolids cake is a broad spectrum material containing many types and quantities of reactants, each mainly organic in nature. Properties of these materials cannot be expected to be entirely fixed in time or quantity. These materials also cannot be expected to have instant reactions with any process, alkali driven or not.

A batch of biosolids cake is typically fairly homogeneous (coming from processing by centrifuge or filter) with respect to content (including moisture) throughout and is gel-like and generally sticky to handle. Diluting the gel-like material into a more dilute fairly homogeneous mixture, say from 25% biosolids to 15% biosolids, does require mixing and does not require aggressive shearing. It is a bit like a jam to a jelly but still a solid.

In terms of free and bound water and dilution, dilution of 25% centrifuged or filtered BSC is easy because the material has retained its bound water and the material is just diluted by adding in additional free water.

This application relates to the manner of processing of solid de-watered sewage and biosolids cake.

### Solids Content, Transportation and Pumpability

For ease of transporting sewage sludge that has been treated and is ready for disposal, the sludge should be:
(a) de-watered such that the water content of the sludge is low (i.e. the solids content is high), and,
(b) of such a low viscosity that the sludge is (economically) pumpable—i.e. for transport of the sludge for disposal, being applied to farm-fields, and other uses.

These two parameters, i.e. high solids-content and low viscosity, conflict.

Most often raw or waste activated sewage sludge sent to the solids management side of the wastewater treatment plant has a solids-content of around three percent, by weight. Flocculation processes usually assist and are common. Thus, in a tonne of this material, 30 kg is solids, and 970 kg is water. At the sewage treatment plant, the raw 3%-sewage is de-watered. Simple de-watering (in which the water is basically squeezed out of the sludge, mechanically, is effective to remove a great deal of the water content of the sludge (i.e is effective to increase the solids content). Simple thickening can be effective to increase the solids content to around 10 or 15%. Centrifuging can be effective to further increase the solids content to i.e. 20%, or even higher. The upper limit of (economical) mechanical de-watering of this type of organic sludge may be considered to be about 25%-solids.

After de-watering to 10% solids, the 30 kg of solids in the initial tonne of raw 3%-sewage, now is accompanied by only 270 kg of water (the other 700 kg of water having been squeezed out). After de-watering to 25% solids, the 30 kg of solids now is accompanied by only 90 kg of water (i.e at 25%-solids, 880 kg or 91% of the water content of the raw 3%-sludge has been squeezed out). Untreated sewage sludge that has been de-watered to 15% solids or more, typically, is stiff, dry and cake-like.

Untreated biosolids 15%-cake and above (Biosolids Content 15%+), unprocessed, is quite unpumpable in the usual liquid handling pumps and a measurement of its viscosity is largely meaningless.

For easy pumpability at ambient temperatures sewage sludge should have a viscosity of 6,000 centiPoise (cP) or less. However, sludge close to 10,000 cP is still just about pumpable (i.e. at increased pumping pressures), but 10,000 cP should be regarded as a reasonable upper limit of viscosity for pumpability. Above that, the sludge requires more expensive mechanical systems and types of pumps. In more detail: for present purposes, sludge at 6,000 cP or less is easily pumpable; sludge between 6,000 and 8,000 cP is pumpable, but not so easily or economically; sludge between 8,000 and 10,000 cP is pumpable, but only with difficulty and increased cost; and sludge above 10,000 cP requires differing types of pumps and larger motors. The viscosity values referred to in this application, measured in the laboratory at room temperature, or at 20-24 C, take into account the preferred end application of the biosolids product as a liquid fertilizer. The viscosity of the biosolids liquid product must take into account the potential for pumping through standard agricultural liquid fertilizer application equipment.

### PRIOR ART

One method of dealing with waste biosolids cake is simply to transport its now lower volume to landfill.

Another alternative is to dry (as by thermal drying) the biosolids cake to a rigid and dry solid pellet form at around 90% biosolids (or more) and treat the pellet sized hard materials as an organic granular fertilizer. Unfortunately, this pellet method is expensive and results in a more expensive fertilizer product from which organic, non-organic and/or dangerous contaminants have not been well removed, with few options.

There are traditional treatment technologies for lowering the viscosity of de-watered sewage sludge and Cake. Lower viscosity is an industrial process objective which assists in reasonable pumpability which in turn affects all aspects of industrial processing of sewage.

Another conventional approach is to raise the temperature to about 160-180 C in a pressure reactor over a period of time of reaction.

Other methods involve additionally raising the pH of the sludge at various temperatures. For instance, alkali, when added to sludge during thermal treatment, raises the pH of the sludge and promotes hydrolysis reactions that break down biological materials in the sludge. It is understood generally that the higher the temperature and pH of the sludge during thermal treatment, the greater the disruption of the sewage sludge and the greater the rate of disruption of that sludge.

Thus, in perhaps over-simplified terms, it is generally understood that the lowest viscosity is procured over time when the sludge is raised to the highest temperature and the highest pH.

It is also understood that there is a diminishing-returns effect, in that, when the temperature and pH have been raised to high levels, the viscosity-lowering effect of a further incremental raise is smaller than the viscosity-lowering effect of the same incremental raise at the lower levels.

Another method is to process relatively dry de-watered Cake having a biosolids content of about 15% or less at atmospheric pressure by a combination of an increased temperature less than 100 degrees Celsius, plus raising the pH, accompanied by violent mechanical shearing.

In many cases, as mechanical/chemical de-watering can readily produce biosolids cake with a higher biosolids content, process water is added to a de-watered Cake with a higher level of biosolids. This is considered a workable but necessary action which, along with the other steps, are required to process the Cake into a pumpable material.

Although effective for purpose, this process is not known for effectively processing high solids Cake of 18-24+% biosolids into a pumpable liquid without adding water to the input material so as to reduce its solids content to less than 15%. This counter-productive step of adding water after transport to process input material, after that material was originally de-watered to a high level before transport, adds cost and complexity which could not, in the prior art, be effectively overcome in an economical industrial process.

A fourth and expensive treatment of incineration is not a good recycling environmental practice.

In one of the present inventor's prior applications the characteristic of pumpability was achieved at previously unknown biosolids contents by an additional step of aggressive shearing. Such shearing attacked the biological materials in the Biosolids Cake and changed their properties to admit of a relatively homogeneous pumpable liquid at 15-18% Biosolids content.

Another method of dealing with waste Biosolids Cake is simply to transport its now lower volume to landfill.

### No Free Water Content

It is generally understood that High Solids Cake (HSBC) and very high Biosolids Cake (VHBSC) beyond that to a lesser extent XHBSC-Cake, (extremely high biosolids content Cake with a solids content of 25% to about 30% or more) despite being de-watered as described above, still contain a measure of loosely bound up (or free water) while remaining in a solid condition. A rule of thumb is that the higher biosolids content cakes appear and act dryer as increased-solidity solid materials. At the extreme, at 90% or more biosolids the XHBSC-Cake is a hard material which must be ground or broken up into a sufficiently pourable dry mass of independent particles for use. An in-use example is pelletized biosolids fertilizer. This is a granular material which is broadcast over the land of application, typically golf courses.

In most cases, solid Cake of 15% to 30% may be further mechanically or chemically de-watered by, for instance, increased and substantially increased mechanical pressure as in a filter or by increased centrifugation. These increased pressures are, however, expensive to obtain and maintain in an industrial process and previously not known to be economically useful beyond drying up an already dryish and solid material to a higher level of the same material.

For industrial purposes the term “Free Water” sets out a useful if somewhat loose criterion for that part of the water content of Cake which may be economically and reasonably extracted by mechanical means. Necessarily, decreasing the level of Free Water in any Cake becomes more and more uneconomic. In many cases, decreasing Free Water in Cakes of 15% biosolids becomes increasingly more expensive as the biosolids content of the material rises from 15% to 24% and even more from 24% through 25%, 26% to 30% and beyond.

By way of description, 15% Biosolids Cake contains a lot more Free Water content than does 30% Biosolids Cake. Above 30% the amount of Free Water becomes increasingly difficult to obtain or measure and by 90% the Biosolids Cake contains no Free Water. The present applicant finds that a reasonable commercial measure of the Free Water limit arises in an about the level of 24%-25% biosolids.

### FURTHER BACKGROUND

Disposal and/or subsequent use of Biosolids Cake remains a serious and costly problem in the field of sewage disposal.

Transportation of the Biosolids Cake is only part of the issue due to high volumes and costly processes.

Efforts continue to efficiently deal both with raw sewage and with the Biosolids Cake waste product and in doing so recover some or all of any commercial utility remaining in the water and the Biosolids Cake components, whether as solid biosolids components or derived liquids. Recovery and ease of commercial utility remain elusive as the processes involved are uncertain, variable and costly to implement on an industrial scale. They also require significant control, measurement and monitoring due to the variability of the sewage materials themselves.

An added complication arises from the all-to-common entrainment of harmful biologicals and inorganics within the waste.

Levels of possible biological and chemical contaminants in biosolids fertilizers are regulated by national and/or regional agencies and wastewater quality entering municipal wastewater plants is also regulated.

### Terminology

In this application the following are defined terms:

Solid in respect of sewage waste indicates a material which is firm and stable in shape, not a liquid or a fluid. A solid as defined herein does not slump appreciably under gravity alone during process-relevant periods of time at ambient or room temperature and atmospheric pressure.

Fluid in respect of sewage waste indicates a material which has no fixed shape and yields easily to external pressure; a liquid or a slurry. As such a slurry as defined herein slumps appreciably under gravity alone in process-relevant periods of time at ambient or room temperature and atmospheric pressure.

Weight/weight (w/w) expressed in %, is the weight of the Biosolids Components in a BSC sample over the total weight of the sample.

Bio-Solids Cake (BSC) is a solid sewage waste bulk material requiring more expensive pumping and/or conveyance systems by commercial waste disposal methods at ambient or room temperature and atmospheric pressure which is the result of processing raw sewage waste through digesters and De-Watering Processes. Typically, Biosolids Cake at ambient temperature—atmospheric pressure is sticky and somewhat gel-like in some of its characteristics. Biosolids Cake contains at least 15-30% Bio-Solids Components (BS). Typical commercial de-watering of sewage waste produces Biosolids Cake in the range of 20-25% biosolids components. For the purposes of this patent application, Biosolids Cake is understood to also include undigested dewatered raw sewage.

Pumpable applies to Bio-Solids sewage waste material in slurry, suspension, fluid or liquid form which has a viscosity of less than 6,000 cP (centi-poise) at ambient temperature and atmospheric pressure.

Pumping includes pressure driven transfer of Biosolids waste material in slurry, suspension, fluid or liquid form. Pumping includes gravitational and fluid pressure flow as a mass.

De-watering Processes (DWP) are commercial processes which reduce the water content of processed sewage waste by mechanical means commonly at ambient temperature or less than 100 degrees Celsius such as filtration, centrifugation and flocculation. DWP are principally directed at removal of Free Water.

Free Water is that watery component of processed sewage sludge which is not tightly bound to the Bio-Solids Component of the Biosolids Cake. Free Water can readily be squeezed out of (removed from) raw sewage or Biosolids Cake.

Bio-Solids (BS) are the organic components of sewage waste which may be extracted from sewage waste in a solid form.

Drying and Dried as used herein are the removal of water from Biosolids Cake principally directed at removal of tightly bound water from the Bio-Solids Component of Biosolids Cake such as by evaporation and/or desiccation. Drying may be partial or complete, with a full range in between. Drying and de-watering may overlap due to;
(a) the wide variability of the biosolids composition itself, and
(b) the free water content of the Biosolids Cake, and
(c) the variability in the nature of the binding between the Free Water and entrained biosolids.

Drying as used herein changes the characteristics of the BS Components.

For instance, in the case of complete drying, bio-solids fertilizer pellets are often manufactured by first applying De-Watering Processes to Biosolids Cake up to a commercially expedient level, and, second, the end product DWBSC (de-watered Biosolids Cake) is dried, as by heating and/or thermal evaporation, through to a hard pellet form. This hard pellet form is typically applied to golf courses and the like by mechanical scattering in the manner of granular inorganic fertilizer.

Bio-Solids Component is that part of Biosolids Cake including only organic materials and excluding the water.

Evaluating includes both concurrent and non-concurrent measurement of or use of viscosity parameters, including plant operation in accordance with previously established viscosity parameters proven successful.

Viscosity as used herein is a measure of the resistance to gradual deformation of a fluid by shear or tensile stress at room ambient temperature and atmospheric pressure as measured in centiPoise (cP).

Mixing and mixing/shearing as used herein apply to application of mixing with the objective of simple mixing in of process water to facilitate the hydration step, i.e. the intimate mixing together of water and the dried or partially dried BioSolids Component in the Cake. This mixing breaks up dried (macroscopic) lumps of material producing a fairly homogeneous liquid or slurry without the destruction of the organics themselves. Mixing/shearing as used herein is different from the shearing/aggressive shearing as described in my prior art patents as shearing/aggressive shearing has the objective of disintegrating/tearing apart organics and cellular structures. Shearing/aggressive shearing is a much much more energy intensive process than mixing/shearing.

### OBJECTS OF THE INVENTION

It is a object to provide stable processes for further commercial processing of high biosolids (HSBSC) content Biosolids Cake derived in bulk from sewage waste into viable improved high biosolids content biologically and environmentally appropriate fertilizing products, as pumpable liquids.

It is a further object to provide for further processing of Biosolids Cake which may be applied across a wide variety of input high biosolids content Biosolids Cake (HSBSC) conditions and compositions.

It is a still further object to render solid Biosolids Cake bulk input material into a verifiable high biosolids content pumpable liquid fertilizer.

It is yet a further object to provide a high biosolids content pumpable liquid which is stable or may be rendered stable by further commercially expedient environmentally appropriate processes.

It is a still further object to provide commercial processes whereby bulk Biosolids Cake may be rendered into high biosolids content pumpable liquid and separable down stream components.

It is an object of the invention to provide for further processing of high biosolids content Biosolids Cake into a high biosolids content pumpable liquid across a wide variety of input BSC compositions, wherein biosolids components comprise 15%-25% or to 30%, or higher, of the composition of the input biosolids Cake without regard to the actual free water components of the input material beyond the results of commercially expedient DWP.

It is an object of the invention to change the properties of the Biosolids Component of Biosolids Cake to achieve at least pumpability at high biosolids concentrations.

It is an object of the invention to achieve high biosolids concentrations in liquids such as slurries wherein the properties of the biosolids components themselves have been altered.

It is yet a further object to render very dry and hard (around 90% Biosolids or more) Biosolids Cake materials into processable biosolids material by mechanical break up of the solid, as by grinding, milling, chopping, etc. to permit effective processing of high biosolids cake with altered properties. This mechanical breaking up provides for particle size reduction.

It is yet a further object of the invention to achieve improvements in the downstream processing capabilities of Biosolids Cake by altering its properties rather than by use of dilution by increasing the Free Water content.

It is a still further object of the invention to provide highly concentrated liquid bio-solids organic fertilizers ready for application by injection and direct absorption into the soil.

An aim of the present technology is to provide a new and more cost-effective way of treating high-bio-solids solid sewage sludge Cakes (HSBSC), particularly:
(a) those Cakes with a solids-content of about 18-24-25% {herein referred to as ‘high-solids cake, HSBSC-cake’} and,
(b) those Cakes with a solids-content higher than HSBSC-cake, namely from about 24%-25% to about 30% or more (herein referred to as an ‘extremely high-solids Cake’, ‘XSBSC-Cake’)
   to lower their viscosity to a pumpable and, more particularly, a readily pumpable liquid to and more efficiently produce a useful bio-solids product.

It is a further objective to obtain a large increase in the extent to which the viscosity of BS Cake, and particularly HSBSC, VHBSC-cake and XHBSC-Cake, can be lowered to economically pumpable ranges, and kept in such ranges, without the use of mechanical severe shearing or complex pressure vessel technology.

A yet further objective is to more efficiently harness reactions to create a greater and more vigorous degree of disruption hydrolysis in complex biological materials and the cellular and other structures within the Cake, and particularly, HSBSC, VHBSC Et XHBSC-Cake than has been done traditionally.

### STATEMENT OF THE INVENTION

The invention provides a process and procedure whereby pumpability of an environmentally appropriate organic fertilizer product may be obtained or increased starting from a solid Biosolids Cake by adding water back in to the solid Biosolids Cake material which has first had varying amounts of bound water (not free water) removed by drying the biosolids component. The water addition includes mixing such as to break down particulate matter produced as a result of the partial or more fully drying process to produce a fairly homogeneous suspension.

More aggressive mixing after adding back water is an option where further reduction in particle size is required.

Wet or dry milling prior to adding back water are other options.

The objective is to reduce particle sizes of particles and lumps produced through the drying step as a process control to achieve a fluid/slurry which can be evaluated and used as a pumpable liquid fertilizer.

The present invention provides a procedure and a product wherein Biosolids Cake, and particularly the Bio-Solids Component of a solid Biosolids Cake, in solid form in bulk, is first exposed to a drying condition at atmospheric pressure, and, then, second re-hydrated by mixing in water, and, third evaluated as to pumpability preferably less than 6,000 cP.

The present invention provides an industrial procedure wherein the drying condition removes water not otherwise considered to be Free Water, preferably at 24-25% bio-solids and beyond. The drying of the invention irreversibly affects the characteristics of the the biosolids component of the solid Biosolids Cake.

At low biosolids content, while still having solid characteristics, i.e. below 24%, the drying of the invention is principally directed at the biosolids component of the solid Biosolids Cake. Particularly, drying at the surface of the solid Biosolids Cakes is preferred over drying generally as volume drying, such as by drying while stirring, will direct the drying towards the Free Water content more than the biosolids component and tend to produce more of an undesirable generally reversible process.

Above 80-85% biosolids content the DBSC (dried Biosolids Cake) no longer exhibits the sticky characteristic which normally inhibits or prevents grinding or pounding the DBSC into a pourable powder of independent particles. As dryness is increased towards this 80-85% limit the level of required stirring or mixing increases. Above this limit grinding or the like is required to produce a pourable powder of independent particles either before re-hydration or as grinding in the presence of water to achieve the same result.

By this process, Biosolids Cake, VHBSC-cake and XHBSC-Cake, are efficiently rendered pumpable over the required reaction period at atmospheric pressure.

The invention provides an industrial procedure wherein:
(a) Biosolids Cake is dried (forming a Dried Biosolids Cake or DBSC) to partially or completely transform the characteristics of the Biosolids Components contained in the Biosolids Cake;
(b) re-hydrating the Dried Biosolids Cake with added water while mixing to form a Re-hydrated Biosolids Product (RBSP);
(c) monitoring and evaluating the viscosity of the Re-hydrated Biosolids Product as a pumpable liquid product, and,
(d) optionally, further hydrating and mixing the Re-hydrated Biosolids Cake until the threshold of pumpability is exceeded; and
(e) optionally further monitoring and evaluating the viscosity of the pumpable RBSP.

The invention also provides an industrial procedure and product for improving pumpability of a mass of solid high solids biosolids cake wherein the procedure does not include aggressive shearing of the mass.

The invention provides an industrial procedure and resulting product for improving pumpability of a mass of solid high solids biosolids cake wherein the biosolids content of the mass is increased to one of 24-25% w/w for 25-30% in the first step and the re-hydration step produces a re-hydrated mass with a biosolids component content of either 18% w/w or 25% or more.

Further the invention provides an industrial procedure for improving pumpability of a mass of solid high solids biosolids cake where in the biosolids component content of the mass is more than 80% in non-sticky hard pellet form after the first step, including a step of grinding the pellets, along with mixing and evaluating.

Further the invention provides an industrial procedure and resulting product for improving pumpability of a mass of solid high solids biosolids cake wherein either the re-hydration step includes the addition of a hydrolizing agent, (preferably lime) and/or an extended period of further thermal incubation following completion of the mixing step.

Further the invention provides an industrial procedure and resulting product for improving pumpability of a mass of solid HSBSC, including a biosolids component of greater than 10% w/w and limited free water, as an organic liquid fertilizer, comprising;
firstly, reducing the free water component by de-watering the mass to a biosolids component of 18% w/w or more or acquiring a dried mass with, and
secondly, increasing the biosolids content of (in description defined as drying, evaporation or desiccation) the mass by more than 5% w/w by partially drying the biosolids component,
thirdly, rehydrating the mass by mixing a quantity of process water back into the mass to produce a re-hydrated mass with a biosolids component of greater than 18% w/w, and then,
evaluating (defined term in in the description, broad) the viscosity of the mass as pumpable.

The invention also provides a procedure and product wherein the procedure is carried out at ambient atmospheric pressure.

### DRAWINGS

FIG. 1 is a table (1) providing process details of the first embodiment.

Title: Table 1 Summary from Individual Thermal Treatment (Drying) (Except Microwave) without Lime

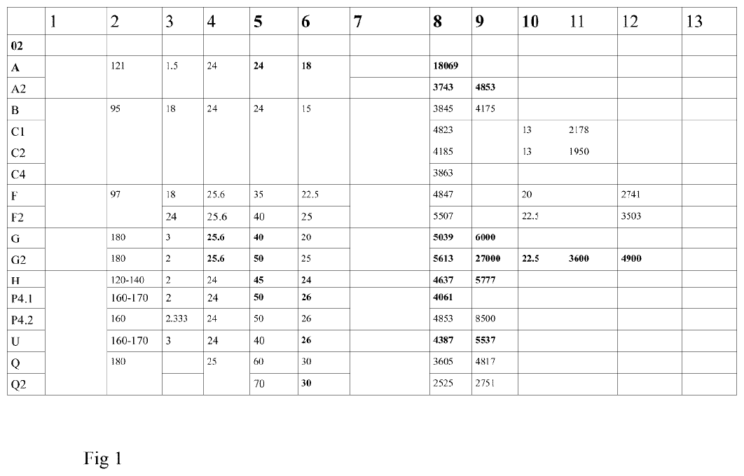

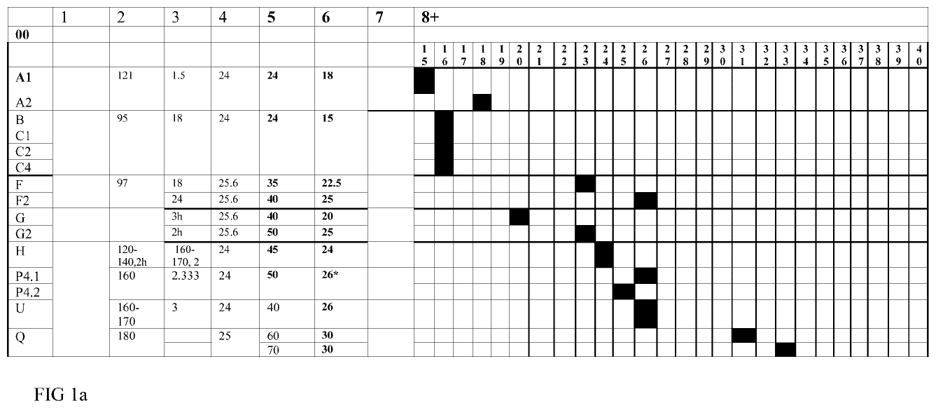

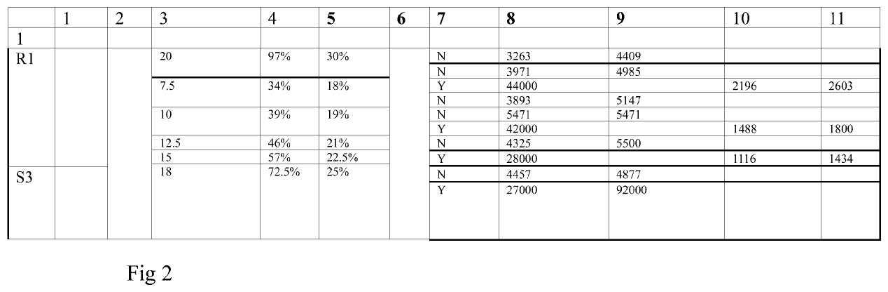

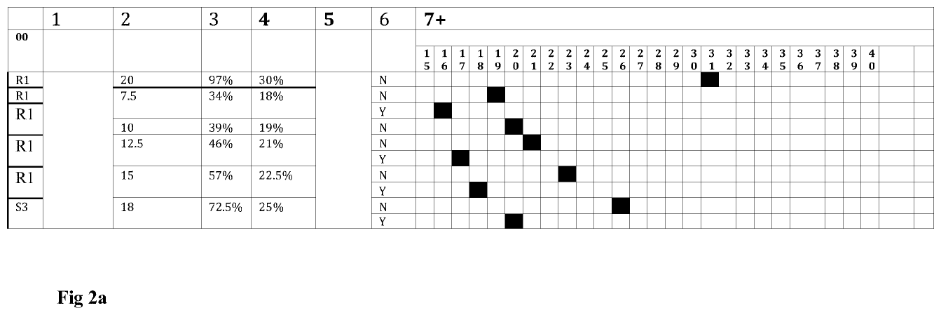

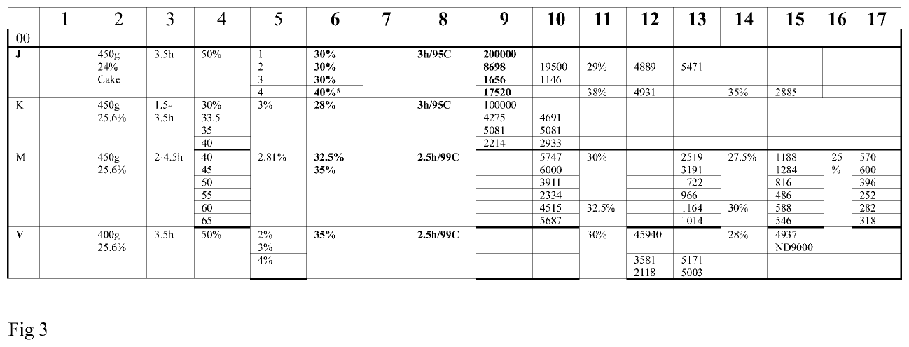

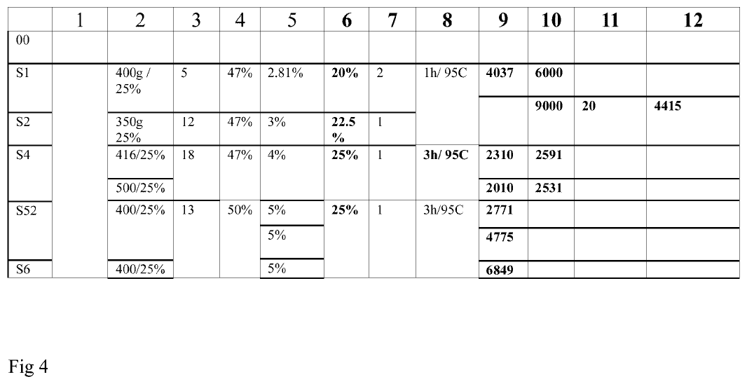

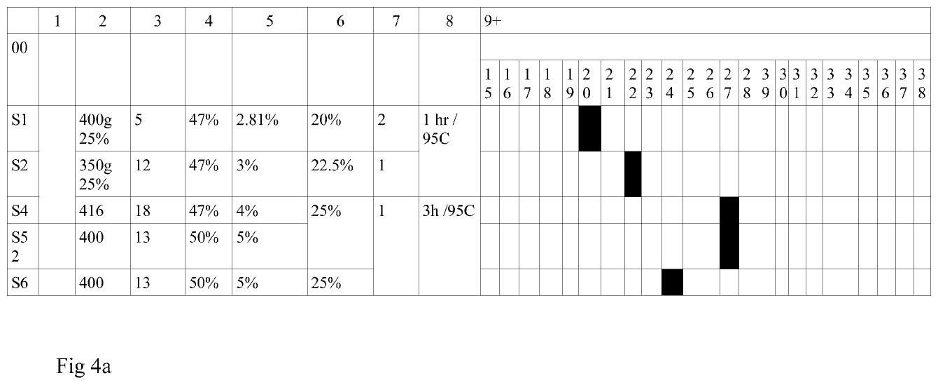

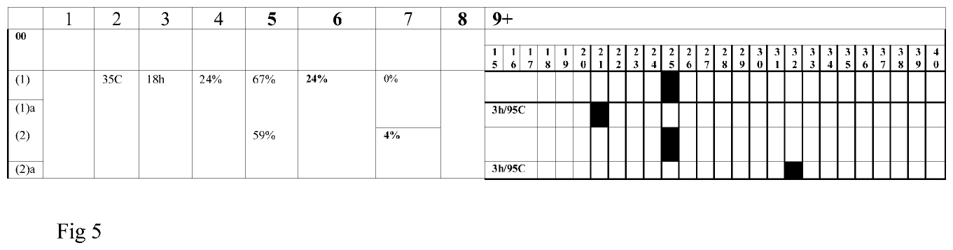

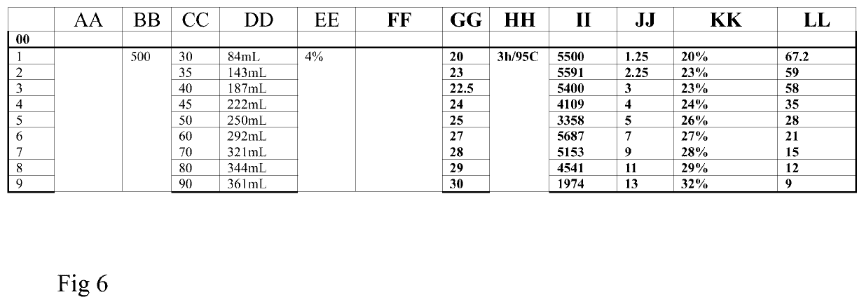

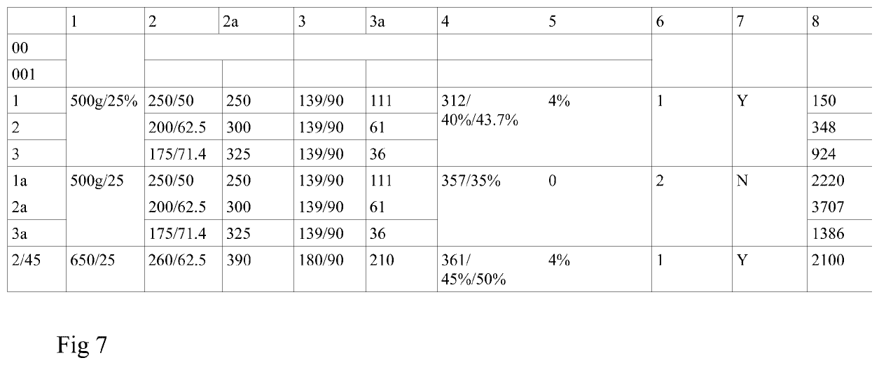

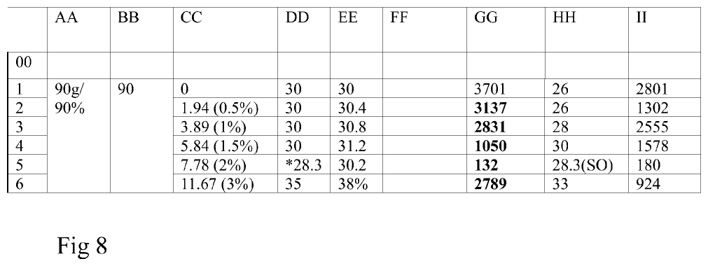

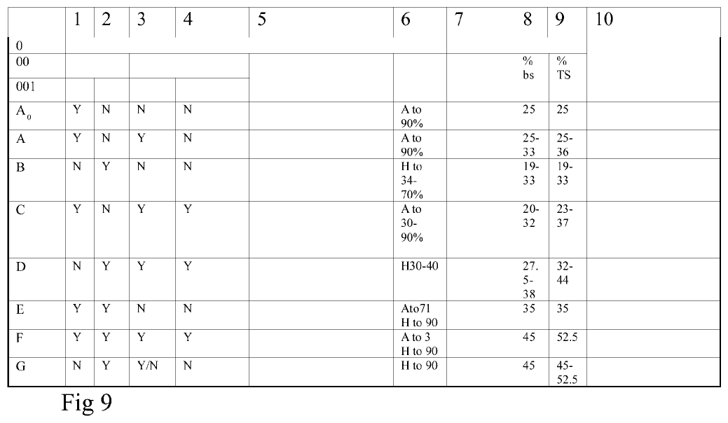

Legend For FIG. 1
The numbers across the top of the table indicate column numbers
The reference letters in the first column are row references
Rows A, B, C1, C2, C4 display prior art results In this table

| | |
|---|---|
| Column 1 Row 02 | Cake Heating System |
| Column 2 Row 02 | Temperature degrees Celsius |
| Column 3 Row 02 | Hold Time (hours) |
| Column 4 Row 02 | Start Cake Solids (BSC) percent (%) |
| Column 5 Row 02 | End Cake Solids (DBSC) percent (%) |
| Column 6 Row 02 | Dilute to Solids content of (RDBSC) |
| | percent (%) |
| Column 7 Row 02 | Aggressively Mix |
| Column 8 Row 02 | Viscosity cP |
| Column 9 Row 02 | Viscosity Next Day cP |
| Column 10 Row 02 | Dilute to: percent (%) |
| Column 11 Row 02 | Viscosity cP |
| Column 12 Row 02 | Viscosity Next Day cP |
| Column 13 Row 02 | Note |
| Column 1 Row A &A2 | Autoclave |
| Column 7 Row A | Shake |
| Column 7 Row A2 | Shear 1 minute |
| Column 1 Rows B, C1, C2, C3 | Waterbath |
| Column 7 Rows B, C1, C21, C4 | Shear 1 minute |
| Column 1 Row F & F2 | Crock Pot |
| Column 7 Row F &F2 | Mix |
| Column 1 Row G& G2 | Saucepan on Hot Plate |
| Column 3 Row G & G2 | Hot plate at temperature 180 degrees |
| | Celsius |
| Column 7 Row G& G2 | vigorously mix |
| Column 1 Row H | Pyrex in Oven |
| Column 7 Row H | vigorously mix |
| Column 13 Row H | Pyrex contents raised to 90° Celsius |
| | in waterbath then transferred to oven |
| Column 1 Row P4.1 | Pyrex in oven |
| Column 7 Row P4.1 | vigorously mix |
| Column 13 Row P4.1 | Diluted to 28%, mixed, held at 95° C. |
| | 3 h and 21 h, diluted to 26% |
| Column 1 Row P4.2 | Pyrex in Oven |
| Column 7 Row P4.2 | vigorously mix |
| Column 1 Row U | Pyrex in Oven |
| Column 7 Row U | vigorously mix |
| Column 3 Row U | Pyrex contents raised to 90 degrees |
| | Celsius in waterbath then transferred |
| | to oven |
| Column 1 Row Q & Q2 | Pyrex in Oven |
| Column 7 Row Q&Q2 | vigorously mix |

FIG. 1a is a summary table (1a) showing the FIG. 1 embodiment graphically.

Title: Thermal Treatment (Drying) Experiments (Except Microwave) without Lime

Estimated Solids content of Liquid Product at 6000 cP (Next Day Values)

Legend For FIG. 1a

| | |
|---|---|
| Rows A, B, C1, C2, C4 | show results described in “prior art”. |
| Column 1 Row 00 | Cake Heating System |
| Column 2 Row 00 | Temperature - degrees Celsius |
| Column 3 Row 00 | Hold Time (hours) |
| Column 4 Row 00 | Start Cake Solids percent (%) |
| Column 5 Row 00 | End Cake Solids percent (%) |
| Column 6 Row 00 | Dilute to Solids content of percent (%) |
| Column 7 Row 00 | Mix |
| Columns 8+ Row 00 | Solids Content of Liquid Product @ 6000 |
| | cP (Next Day Values) in percent (%) |
| Column 1 Row A1 & A2 | Autoclave (No evaporation) |
| Column 7 Row A1 | Shake |
| Column 7 Row A2 | Shear 1 minute |
| Column 1 Rows B.C1, C2, C4 | Waterbath (No evaporation) |
| Column 7 Rows B.C1, C2, C4 | Shear 1 minute |
| Column 1 Row F & F2 | Crock Pot |
| Column 7 Row F & F2 | Mix |
| Column 1 Row G &G2 | Saucepan on Hot Plate |
| Column 2 Row G & G2 | Hot Plate Temperature 180° C. |
| Column 7 Row G &G2 | vigorously mix |
| Column 1 Rows H, P4.1, P4.2 | Pyrex in Oven |
| Column 7 Row H, P4.1, P4.2 | vigorously mix |
| Column 1 Row U, Q | Pyrex in Oven |
| Column 7 Row U, Q | vigorously mix |

FIG. 2 is a table (2) providing process details of the second embodiment.

Title: Table 2 Microwave Thermal Treatment (Drying) without Lime

Legend For FIG. 2

| | |
|---|---|
| Column 1 Row 1 | Cake Heating System |
| Column 2 Row 1 | 24-25 percent (%) (BSC) |
| Column 3 Row 1 | Hold time in minutes |
| Column 4 Row 1 | End Cake Solids (DBSC) percent (%) |
| Column 5 Row 1 | Dilute to Solids content of (RDBSC) |
| | percent (%) |
| Column 6 Row 1 | Mix |
| Column 7 Row 1 | Heat 3 hours at 95 degrees Celsius |
| Column 8 Row 1 | Viscosity cP |
| Column 9 Row 1 | Viscosity Next Day cP |
| Column 10 Row 1 | Dilute to 15 percent (%) Viscosity cP |
| Column 11 Row 1 | Viscosity Next Day cP |
| Column 1 Row R1 | Microwave |
| Column 6 Rows R1& S3 | Aggressive mix for 1 minute |
| Column 1 Row S3 | Microwave |
| Column 6 Row S3 | Aggressive mix for 1 minute |
| Column 10 Row S3 | Dilute and Retest |
| Column 11 Row S3 | Dilute and Retest |
| N = no | |
| Y = yes | |

FIG. 2a is a summary table (2) showing the FIG. 2 embodiment graphically.

Title: TABLE 2a Microwave Thermal Treatment (Drying) without Lime

Legend For FIG. 2a

| | |
|---|---|
| Column 1 Row 00 | Cake Heating System |
| Column 2 Row 00 | Hold Time in Minutes |
| Column 3 Row 00 | End Cake Solids (DBSC) percent (%) |
| Column 4 Row 00 | Rehydrate to Solids content of percent (%) |
| Column 5 Row 00 | Mix |
| Column 6 Row 00 | Heat 3 hours at 95 degrees Celsius |
| Column 7+ Row 00 | Solids Content of Liquid Product @ 6000 cP |
| | (Next Day Values) |
| Column 1 Row R1 | Microwave 1000 watt |
| Column 5 Row R1 | Aggressive mixing for 1 minute |
| Column 1 Row S3 | Microwave 1000 watt |
| Column 5 Row S3 | Aggressive mixing for 1 minute |
| N = no | |
| Y = yes | |

FIG. 3 is a table (3) providing process details of the third embodiment.

Title: Table 3 Thermal Treatment (Conventional Drying Except Microwaved) with Lime Addition

Legend For FIG. 3

| | |
|---|---|
| Column 1 Row 00 | Cake Heating System 180-200 degrees Celsius |
| Column 2 Row 00 | Cake Weight grams + BS % |
| Column 3 Row 00 | Temperature Hold Time in hours |
| Column 4 Row 00 | After Cook solids % |
| Column 5 Row 00 | Cal 85% added per 24% BS |
| Column 6 Row 00 | Dilute to BS content of |
| Column 7 Row 00 | Mix |
| Column 8 Row 00 | Incubate (hours/temperature - degrees |
| | Celsius) |
| Column 9 Row 00 | Viscosity cP |
| Column 10 Row 00 | Next Day Viscosity cP |
| Column 11 Row 00 | Dilute to BS Content of |
| Column 12 Row 00 | Viscosity cP |
| Column 13 Row 00 | Next Day cP |
| Column 14 Row 00 | Dilute to BS content of |
| Column 15 Row 00 | Viscosity cP |
| Column 16 Row 00 | Dilute to BS content of |
| Column 17 Row 00 | Viscosity cP |
| Column 1 Row J | Convection Cook |
| Column 7 Row J | Mix for 1 minute |
| Column 1 Row K | Convection Cook |
| Column 7 Row K | Mix for 1 minute |
| Column 1 Row M | Convection Cook |
| Column 7 Row M | Mix for 1 minute |
| Column 1 Row V | Convection Cook at 200 degrees Celsius |
| Column 7 Row V | Mix for 1 minute |

FIG. 4 is a table (4) providing process details of the forth embodiment.

Title: Table 4 Microwave Thermal Treatment (Drying Experiments with Lime Addition)

Legend For FIG. 4

| | |
|---|---|
| Column 1 Row 00 | Cake Heating System |
| Column 2 Row 00 | Cake Weigh (grams)/% BS |
| Column 3 Row 00 | Temperature hold time in minutes |
| Column 4 Row 00 | After Cook Solid (DBSC) % |
| Column 5 Row 00 | Cal 85 based on 24% BS (%) |
| Column 6 Row 00 | Dilute to BS percent (%) of |
| Column 7 Row 00 | Mix (RDBSC) for minutes |
| Column 8 Row 00 | Incubate hours/degrees Celsius |
| Column 9 Row 00 | Viscosity cP |
| Column 10 Row 00 | Next Day Viscosity cP |
| Column 11 Row 00 | Dilute to BS Content of |
| Column 12 Row 00 | Viscosity |
| Column 1 Rows S1, S2, 54 | Microwave 1000 watt |
| Column 1 Rows S52, S6 | Microwave 1000 watt |

Note:
RDBSC in rows S52 & S6 receive aggressive mixing for 1 minute

FIG. 4a is a summary table (4a) showing the FIG. 4 embodiment graphically.

Title: Microwave Thermal Treatment (Drying) Experiments with Lime

Legend For FIG. 4a

| | |
|---|---|
| Column 1 Row 00 | Cake Heating System |
| Column 2 Row 00 | Cake Weight grams/% BS |
| Column 3 Row 00 | Hold time in minutes |
| Column 4 Row 00 | After cook Solid percentage (%) |
| Column 5 Row 00 | Cal 85, % based on 24% BS |
| Column 6 Row 00 | Dilute to BS % of |
| Column 7 Row 00 | Mix (RDBSC) time in minutes |
| Column 8 Row 00 | Incubate (hours at degrees Celsius) |
| Column 9+ Row 00 | Solids Content of Liquid Product @ 6000 cP |
| | (Next Day Values) |
| Column 1 Rows S1, S2, | Microwave 1000 watt |
| S52, S6 | |

FIG. 5 is a table (5) providing process details of the fifth embodiment with air drying.

Title: Table 5: Non-Thermal Air Drying [symbol] (Low Temperature) without and with Lime

Solids Content of Liquid Product at 6000 cP (Next Day Values)

Legend for FIG. 5

| | |
|---|---|
| Column 1 Row 00 | Cake Drying System |
| Column 2 Row 00 | Temperature (degrees Celsius) |
| Column 3 Row 00 | Hold time in hours |
| Column 4 Row 00 | Start Cake Solids BSC percent (%) |
| Column 5 Row 00 | End Cake Solids DBSC percent (%) |
| Column 6 Row 00 | Dilute to Solids content of (RDBSC) |
| | percent (%) |
| Column 7 Row 00 | Cal 85, % based on 24% BS |
| Column 8 Row 00 | Mix |
| Column 9+ Row 00 | Solids Content of Liquid Product @ 6000 |
| | cP (Next Day Values) |
| Column 1 Rows (1), (1)a | Salton Air Dryer |
| Column 1 Rows (2), (2)a | Salton Air Dryer |
| Column 8 Rows (1), (1)a, | Aggressive mixing |
| Column 8 Rows (2), (2)a | Aggressive mixing |
| Column 9+ Row (1) | No Heat |
| Column 9+ Row (2) | No Heat |

FIG. 6 is a table (6) providing process details of a variation of the fifth embodiment.

Title: Table 6. Drying without Heat ie Dehumidification Drying Followed by Aggressive Mixing

Legend For FIG. 6

| | |
|---|---|
| Column AA Row 00 | Cake Drying System |
| Column BB Row 00 | Cake Weight 25% (grams) |
| Column CC Row 00 | After Drying Solid % |
| Column DD Row 00 | Water Removed - milliliters |
| Column EE Row 00 | Cal 85 based on 24% BS (%) |
| Column FF Row 00 | Mixing |
| Column GG Row 00 | Rehydrate % BS |
| Column HH Row 00 | Incubate (hours/degrees Celsius) |
| Column II Row 00 | Viscosity (cP) |
| Column JJ Row 00 | Drying Time (approximate) hours |
| Column KK Row 00 | 6000 cps liquid BS content at |
| Column LL Row 00 | Water removed per hour |
| Column AA Rows 1-9 | Dehumidifier (rating 70 p/24 hours) |
| Column FF Rows 1-9 | 60 seconds-90 seconds increasing down |
| | the table with dryer material |

FIG. 7 is a table (7) providing process details of another embodiment with the drying step a combination of air drying and thermal drying.

Title: Table 7. Dehumidification Drying with Convention Oven Completion

Legend For FIG. 7

| | |
|---|---|
| Column 1 Row 00 | Starting BS weight (g)/BS % |
| Column 2 Row 00 | Dehumidify to |
| Column 3 Row 00 | Heat Dry To |
| Column 4 Row 00 | Rehydration to (Total weight/% BS/% TS) |
| Column 5 Row 00 | Cal 85, % added |
| Column 6 Row 00 | Aggressive Mixing - minutes |
| Column 7 Row 00 | Incubate 3 hours/95 degrees Celsius |
| Column 8 Row 00 | Viscosity cP |
| Column 2 Row 001 | Weight/percent (%) |
| Column 2a Row 001 | Water Removed/grams |
| Column 3 Row 001 | Weight/percent (%) |
| Column 3a Row 001 | Water Removed/grams |
| Column 4 Row 001 | Weight/percent (%) |
| Column 5 Row 001 | based on 25% BSC |
| Y = yes | |
| N—no | |

FIG. 8 is a table (8) providing process details of another embodiment with air drying to 90%, rough grinding and re-hydration with/without lime addition.

Title: Table 8. Rehydration 90% Air Dried Biosolids (Quick Mix) to 45% Pumpable Liquid: Effect of Lime Concentration

Legend For FIG. 8
90% BSC prepared from 25% cake by air drying using a (Food) air dryer.
90% Dry material was rough ground in a Ninja⁽ ™⁾
professional signal homogenizer (approx time 10 seconds)

| | |
|---|---|
| Column AA Row 00 | Starting BS Weight/% |
| Column BB Row 00 | Water Added - grams |
| Column CC Row 00 | Add Ca(OH)2 (based on 4% Cal85/Kg of 25% |
| | Cake (grams/%) |
| Column DD Row 00 | BS Concentration |
| Column EE Row 00 | TS Concentration |
| Column FF Row 00 | Mix augur BD hand mixer - 30 seconds |
| Column GG Row 00 | Viscosity Start |
| Column HH Row 00 | Next Day Dilute to [BS] % |
| Column II Row 00 | Viscosity (cP) |

FIG. 9 (table 11 is a table providing a summary of options in respect of Dried Biosolids Cake materials.

Title: Table 11 Summary of Options: Drying to Produce High Concentration Pumpable Liquids or Slurries

Legend For FIG. 9

| | |
|---|---|
| Column 1-6 Row 0 | Process Combination |
| Column 7-9 Row 0 | Product Properties |
| Column 10 Row 0 | Key Parameter Impact |
| Column 1-2 Row 00 | Drying Process |
| Column 3-4 Row 00 | Liquid Rehydraftion |
| Column 6 Row 00 | Drying Range Achieved due to A and H |
| | (A = Air drying; H = thermal drying |
| Column 7 Row 00 | Consistency |
| Column 1 Row 001 | Air |
| Column 2 Row 001 | Heat |
| Column 3 Row 001 | Lime Added |
| Column 4 Row 001 | Liquid Added |
| Column 5 Row Ao | Air drying followed by hydration thoughout |
| Column 5 Rows Ao, A, | pumpable liquid |
| B, C, D, | |
| Column 5 Row A | Air drying followed by rehydration + lime |
| Column 10 Row A | As lime dose increased achievable solids |
| | concentration of pumpable liquid increased |
| Column 5 Row B | Partial heat drying following by rehydration, |
| | no lime |
| Column 10 Row B | As extent of heat drying increased from (34- |
| | 70%) achievable solids concentration of |
| | pumpable liquid increased. |
| Column 5 Row C | Partial air drying, rehydration with lime + |
| | heat |
| Column 10 Row C | As extend of air drying increased from |
| | (30->90%) achievable solids concentration |
| | of pumpable liquid increased. |
| Column 5 Row D | Partial heat drying, rehydration, with |
| | lime + heat |
| Column 10 Row D | As lime dose increased achievable solids |
| | concentration of pumpable liquid increased. |
| Column 5 Row E | Air drying, heat drying finish rehydration |
| Column 5 Row F | Air drying, heat drying finish rehydration |
| | with lime + heat |
| Column 5 Row G | Heat drying followed by rehydration +/− lime |
| Column 10 Row G | Liquid heating had no beneficial effect. Lime |
| | addition no initial beneficial effect. |
| Y = yes | |
| N = no | |

### OPERATIONAL DETAILS—PREFERRED EMBODIMENTS

Some examples of preferred procedures that embody the present technology will now be described.

The present Bio-Solids Cake treatment procedure can be controlled by monitoring/evaluating the pumpability of results until a required degree of pumpability has been achieved and then periodically re-hydrating and evaluating for a preferred degree of pumpability over a period of time.

### Preferred Embodiments

The first 5 rows of Table 1, FIG. 1, (rows A, B, C1, C2, C4) show prior art examples for comparison.

The first preferred embodiment shown in FIG. 1, at rows F through Q, provides a process for converting 24% (no or limited free water) Biosolids Cake (BSC), a solid material, into a pumpable liquid, preferably with a viscosity of less than 6,000 cP, comprising:
(a) firstly, thermally treating a mass of the Biosolids Cake by conventional heating, and,
(b) secondly, drying the mass of Biosolids Cake (preferably without microwaves or added lime) beyond the free water point to a concentration of more than 35% Biosolids, preferably 35-37% Biosolids, to form a dehydrated {dried} Dried Biosolids Cake, and
(c) thirdly, holding the drying Biosolids Cake mass at or above a certain drying temperature for the drying period, and,
(d) fourthly, mixing, preferably thoroughly mixing, the dehydrated Dried Biosolids Cake with water to re-hydrate the Dried Biosolids Cake back to a re-hydrated mass (RDBSC) with a biosolids content higher than 24%, and,
(e) fifthly, evaluating the resulting viscosity of the re-hydrated RDBSC for pumpability, preferably at less than 6,000 cP.

Further, this first embodiment may include additional repetitive extra steps each being:
(a) the addition of supplemental water (biosolids remaining higher than 20%), and,
(b) evaluating the resulting viscosity of the re-hydrated RDBSC for pumpability, preferably at less than 6,000 cP.

Details of the operation of the first embodiment are shown in FIG. 1 juxtaposed to the prior art processes which are detailed in rows A, B and C1 through C4, involving:
(a) autoclaving at an elevated temperature (121° C.) and pressure but without drying/evaporation (Ref. A) and,
(b) waterbath heating to 95° C. but without evaporation/drying (Ref B, C1, C2, C4).

In these prior art cases a mass of 24% Cake, col 4, was subjected to prolonged heating at 121 and 95 degrees Celsius (col 2) for 1.5 and 18 hours (col 3) respectively. In each case the resultant 24% (non-evaporated) Cake was diluted with water to 18 and 15% solids as noted in column 6 by mixing, col 7, and the viscosity evaluated as shown in col 8. As shown in this prior art, mixing water into the autoclaved and diluted at 18,069 cP Cake at 18%, by shaking, as in row A, produced an unpumpable material, col 8. Adding an aggressive mixing component, referred to and known as shearing/aggressive shearing (such as provided in a household blender for small batches), to the mixing reduced the 18% mix to pumpable at 3,743 cP. Shearing was accomplished by a Ninja Single Serve™ blender. By the next day the viscosity of this batch (ambient temperature) had increased on its own to 4,853 cP irreversibly.

The water bath prior art examples shown in rows B and C (95 degrees Celsius) for 18 hours (col 2 and 3) were diluted to 15% solids and sheared to reach a viscosity of about 4,000 cP.

As shown in row F, a first preferred embodiment, a 25.6% solid Cake material when heated to 97 C for 18 and 24 hours, with evaporation, reached biosolids solids contents of 35% and 40% respectively. Rehydration dilution by mixing process water back in to reduce the biosolids content back to 22.5% and 25% respectively, upon evaluation, produced a pumpable fluid at 4,847 cP and 5507 cP respectively, col 8, which viscosity was further reduced by mixing in further water (20% and 22.5%, col 10). In this example, pumpability at the expressed viscosity was achieved with no or only very minor reductions in the biosolids content of the initiating 25.6% material.

As shown in row G, a first preferred embodiment, the sample at 25.6% BS was heated on a hot plate with a temperature setting of 180 C for periods of 3 and 2 hours, col 3, respectively, to achieve an end Cake solids content of 40% and 50%, col 5. As in cols 5 and 6, this end Cake was rehydrated and diluted back to 20 and 25% by mixing and pumpability evaluated, col 8, at 5,039/cP and 5613/cP. In this case viscosity was shown as rising by the next day, with 1 sample rising to 27,000/cP, an unpumpable result. Further dilution to 22.5% again reduced the viscosity to pumpable ranges which held for the then-following next day, while continuing to rise. It is noted that hot plate heating resulted in wider variation in results which were alleviated in part by a spatula mixing.

As shown in rows H, P4.1, P4.2, U and Q, a first preferred embodiment, heating BSC of 24 and 25% solids at elevated oven temperatures for short periods (col 2 and 3) resulted in End Cake Solids of 45 to 70%, col 5. Upon dilution as shown in col 6 and mixing, col 7, in each case a readily pumpable viscosity was obtained, col 8. In the case of row P4,2 the low viscosity degraded by the next day, i.e. to 8,500 cP.

The individual elements of the first embodiment shown in FIG. 1 are displayed in FIG. 1a in a graphic manner particularly focused on the BS content of the resultant product when evaluated at 6,000 cP. In each case this resulted in a pumpable liquid with a viscosity of 6,000 cP along with a Solids Content of 20%, and 23% to as much as 33%. Rows A, B, and C1-C4 of the FIG. 1a table show the range of results for the prior art. Rows F to Q show the range of the results from the present procedure.

A second preferred embodiment is shown in FIG. 2 wherein the thermal drying is carried out by microwave heating. In this embodiment 24-25% Biosolids Cake were subjected to microwave heating to evaporate/reduce the initial Biosolids Cake to the Dried Cake Solids (DBSC) values shown in col 5. The hold times are set out in col 3. Dilution and re-hydration at ambient temperature (RDBSC) to the values shown in col 6 plus an aggressive mixing in a blender (small batch mixing) upon evaluation produced pumpable liquids as identified in col 8. Notably, the addition of a 3 hr/95 degrees Celsius heating step following the mixing, upon evaluation, yielded an unsatisfactory material with an unpumpable viscosity until greatly further diluted to 15% solids as shown in col 10.

The results shown in FIG. 2 are displayed graphically in FIG. 2a. FIG. 2a indicates the biosolids content of each liquid product which gives a viscosity of 6000 cP. The additional heating step after mixing upon evaluation degraded all of the results.

A third preferred embodiment provides a controlled process as in the first embodiment with the additional steps of the addition of a hydrolyzing agent, preferably time, to the re-watering step plus a period of heated incubation after the hydrolyzing agent (lime) is mixed in. Details of the operation of the third embodiment are shown in FIG. 3.

In row J of FIG. 3, 450 g of 24% Biosolids Cake is held in a convection oven set at 180-200 degrees Celsius for a period of 3.5 hours (col 3) with the resultant drying leaving a Dried Biosolids Cake with After Cooking Solids content (col 4) of 50%. As shown in cell J1-4 time in the form of Cal85™ (85% calcium oxide supplied by Carmeuse Lime, Ingersoll, Ontario) is added to the Dried Biosolids Cake in the amounts specified as 1, 2, 3, and 4% (ie 1-4 g per 100 g of 24% original Biosolids Cake (BSC). As shown in col 6 the Dried Biosolids Cake material of col 4, 5 is rewatered (re-hydrated) by dilution to a biosolids content of 30% and 40% as shown and the RDBSC material mixed for 1 minute. An additional step of thermal incubation, col 8, is included as 3 hours at 95 degrees Celsius. Evaluation of resulting viscosity showed unpumpable initial viscosities (col 9) for the 50%/1%/30% and the 50%/2%/30%, with a significant next day increase in the later. Further rewatering of the 50%/2%/30% (after cook solids/Cal85/Diluted BS) material to 29% biosolids content resulted upon evaluation in the pumpable liquid of the invention upon completion. This remained liquid through the next day.

In row K of FIG. 3 450 Grams of 25.6% Biosolids Cake was dried in a convection oven set at 180-200 degrees C. for variable periods of 1.5 to 3.5 hours to dry the Biosolids Cake to 30% through 40% biosolids, see col 4. Adding 3% Cal 85 (col 5), rewatering to 28% by dilution, mixing for 1 minute to form a RDBSC and incubation for 3 hours at 95 degrees Celsius produces viscosity evaluations as shown in cell K,9 as unpumpable (100,000/cP) for the 30% after-cook-solids-material and pumpable for the higher after-cook-biosolids content RDBSC materials. The pumpable evaluations remained through the next day (col 10).

In row M of FIG. 3 the same amount of 450 grams of 25.6% BSC was held at the drying temperature of 180-200 degrees Celsius for a drying time ranging between 2 to 4.5 hours (col 3) to produce an Dried Biosolids Cake with After-Cook-Solids content ranging between 40% and 65% (col 4). Processing with the addition of Cat 85 time, dilution to 32.5% and 35% Solids Content, mixing for 1 minute and incubation cooking for 2.5 hours at 99 degrees C., upon evaluation, produced a next day viscosity of 6,0000 or less for each After Cook content, col 10.

In the FIG. 3 table (3) it is noted that columns 6, 11, 14, 16 refer to biosolids content. Total solids content would be higher due to the amount of Cal 85 added. Further, FIG. 3 shows aggressive mixing for 1 minute which describes mixing the material by breaking apart solid particles, Lumps or pieces. For softer materials a simple mixing is sufficient. For the harder materials a more aggressive mixing is required to break down the hard component as by milling after adding back water. Wet or dry milling prior to adding back water are other options. The objective is to reduce particle sizes of solid particles produced through the drying step and not changing the properties of the Biosolids Cake in the material by that action alone. As the dryer materials become harder and more brittle, some breakup of the harder particles is required for efficient processing.

Further processing steps of water dilution on the next day upon evaluation further reduced the viscosity each time as shown in columns 11 through 17. In summary, in each of the row M cases an initial Biosolids Cake having a biosolids content of 25.6%, a solid, has been rendered pumpable at an elevated biosolids content and very pumpable, i.e low viscosity, at its original biosolids concentration of 25%.

In row V a 400 g mass of 25.6% BSC was heated and dried in a convection oven set at 200 degrees Celsius at atmospheric pressure for 3.5 hours to produce a Dried Biosolids Cake with After Cook Solids content of 50%. Mixing and diluting in the presence of added Cal85 lime at 2, 3 and 4% with dilution to the equivalent of 35% biosolids content to form a RDBSC plus incubation at 99 degrees Celsius for 2.5 hours, upon evaluation, produced a pumpable liquid at less than 6,000 cP upon the further steps of dilution to 30% and 28%, plus evaluation, as shown in columns 13 through 15 (ND=next day value).

A graphical summary of the operation of the third preferred embodiment is shown in FIG. 3a. FIG. 3a indicates the biosolids content of each Liquid product which gives a viscosity of 6000 cP.

A fourth preferred embodiment provides a controlled process as in the third embodiment wherein heating is provided by microwave energy and is detailed in the table shown FIG. 4 (table 4).

In this embodiment, S1, 400 grams of Biosolids Cake at 24% was microwaved for 5 minutes to a dry condition (approximate solids content of 47% based on the 24% Biosolids Cake figure), i.e. dried by ½ of the solids content. Addition of Cal85 time at 2.81% (based on the 24% Biosolids figures), dilution to a biosolids content of 20%, mixing for 2 minutes and incubation for 1 hour at 95 degrees Celsius resulted in a pumpable liquid with an initial viscosity of 4037 cP, which is noted to rise over the course of the next day but still pumpable.

In this embodiment, S2, 350 grams of biosolids at 25% was microwaved for 12 minutes to a solids content of 47% based on the 24% BSC figure, i.e dried by approximately ½ of the solids content. Addition of Cal85 time at 3% (based on the 25% BS figures), dilution to a biosolids content of 22.5%, mixing for 1 minute and incubation for 1 hour at 95 degree Celsius resulted in a barely pumpable liquid with an initial viscosity of 9000 cP. Further dilution to a biosolids content of 20% reduced the viscosity to 4415 cP.

In this embodiment, S4, 416 and 500 grams respectively of Biosolids Cake at 24% was microwaved for 18 minutes to a dry condition (approximate solids content of 47% based on the 24% Biosolids Cake figure), i.e. dried by ½ of the solids content. Addition of Cal85 lime at 4% (based on the 24% biosolids figures), dilution to a biosolids content of 25%, a more aggressive mixing as by a blender in a blender for 1 minute and incubation for 3 hours at 95 degree Celsius resulted in a pumpable liquid with an initial viscosity of 2010 and 2310 cP, respectively, which is noted to rise over the course of the next day but stilt pumpable.

In this embodiment, S52 and S6, 400 grams of BSC at 24% was microwaved for 13 minutes to a solids content of 50% based on the 24% BSC figure, ie dried by ½ of the solids content. Addition of Cal85 lime at 5% (based on the 24% BS figures), dilution to a biosolids content of 25%, a more aggressive mixing as by a blender in a blender for 1 minute and incubation for 3 hours at 95 degree Celsius resulted in a pumpable liquid with an variable initial viscosity of between 2771 cP and 6849 cP.

At tower temperatures and times this preferred embodiment of the process may require original (first) re-watering to a biosolids level lower than the original biosolids level but in any event at biosolids content of 20% or more.

A graphical summary of the operation of the fourth preferred embodiment is shown in FIG. 4a (table 4a). FIG. 4a indicates the biosolids content of each liquid product which gives a viscosity of 6000/cP.

FIG. 5 (table 5) shows the fifth embodiment of the invention in graphical format for non-thermally supported air drying (by means of a Salton™ air dryer) at above ambient temperatures without and with a lime addition. FIG. 5 indicates the biosolids content of each liquid product which gives a viscosity of 6000/cP.

In each case a Biosolids Cake sample was air-dried at 35 C for 18 hours to dry from Biosolids Cake 24% through to a Dried Biosolids Cake at 67% and 59% as shown in column 5. Re-watering dilution back to 24% biosolids for a RDBSC plus aggressive mixing (as by a blender) for 30 seconds, for the cases of both Cal85 addition or not, column 7, upon evaluation, provided a range of BS content for 6,000/cP pumpable liquid ranging from 21% through 32% depending on incubation times of 0 (no incubation) and 95 degrees Celsius for 3 hours and presence or absence of Cal85 in the mix, see column 9.

FIG. 6 (table 6) shows a variation on the non-thermal drying fifth embodiment of FIG. 5 by means of a dehumidifier rated at 70p (pints)/per 24 hours period. The dehumidifier is not providing significant heat to the process above ambient. In this embodiment 500 gram samples (col BB) of 25% BSC were dried to produce Dried Biosolids Cake end-of-drying solids contents ranging in the DBSC from 30-90% as shown in col CC. In each case re-watering by dilution to a RDBSC with a biosolids content of 20-30% plus the addition of 4% Cal85 and an aggressive mixing (as by a small batch blender) from 60-90 seconds plus the additional step of incubation after mixing for 3 hours at 95 degrees Celsius, upon evaluation, produced a pumpable liquid at 6,000 cP ranging from 20% biosolids through to 32% solids. It is noted that the mixing time component shown in column FF was increased from 60-90 seconds with the increasing dryness of the material itself in order to achieve particle breakdown and mixing. Air drying as with the fifth preferred embodiment provides the controlled process of the first and second embodiments at a lower temperature, preferably 35° C., but requires a much longer hold time requirement, such as 18 hours, to achieve the evaluated results.

FIG. 7 (table 9) provides another embodiment with a combination drying step. As shown in column 1, 500 and 650 gram samples of 25% Biosolids Cake were (dried) dehumidified to 50-71.4% BS as per column 2. Column 2 shows the final weight and % biosolids content upon completion of this dehumidification step. At col 2a the amount of water removed by dehumidification is also specified.

The second step in the drying process in this embodiment was provided by thermal drying which dried the sample weights further to 139 and 180 gram weights respectively (as set out in column 3) for a 90% biosolids content by removing the amount of water set out in column 3a from the sample.

Batch rehydration by mixed-in water addition to the levels shown in column 4 (35, 40 and 45%) with each of Cal85 lime addition and incubation for 3 hours at 95 degrees Celsius resulted in evaluation levels as pumpable liquids with the viscosities shown in column 8. Aggressive intermixing of the reconstituting water, the cal85 and the dried Biosolids Cake (90%) was included in the process by mixing for 1-2 minutes as shown in col 6. A further included step of incubation for 3 hours at 95 degrees Celsius (Column 7) following or together with the intermixing steps showed evaluations with improved pumpability as shown in col 8.

FIG. 8 (table 10) provides another embodiment. A 90% DBSC mass of material was prepared from a 25% Biosolids Cake by air drying using a food air dryer. Ninety grams of the Dried Biosolids. Cake 90% material, being hard and somewhat brittle, was rough ground in a Ninja™ single serve homogenizer (approx 10 seconds) and then processed in accordance with FIG. 8 (table 10) (col AA-H). In each case re-hydration water was added in the amount of 90 grams to form the RDBSC. As set out in col CC an amount of lime, being Ca(OH)2, was added. This resulted in a mix with a BS and a TS (total solids) concentration as set out in columns DD and EE, when mixed with a auger-style hand mixer for about 30 seconds, column FF. Evaluation of viscosity confirmed a pumpable liquid with gel like characteristics at 3,700 cP or less, well within the appropriate range for use in an industrial process. A further step taken the next day by the addition of small amounts of additional water to further dilute or re-hydrate the mix improved the evaluated viscosity in all but 1 instance. In case number 5 the initial mixed RDBSC showed signs of some settling out. While an approximate viscosity of 180 was measured and assigned, viscosity drops during measuring as settling out progresses.

FIG. 9 (Table 11) presents a summary of at least some process options involving a dehydration step to produce high biosolids concentration pumpable liquids or slurries at least partly based on the foregoing examples. As indicated in columns 1-2, the drying step may involve air or heat drying or a combination thereof. Heat drying, as understood here, includes microwave drying. As indicated in columns 3, 4, the aqueous re-hydration step may or may not include addition of lime or other hydrolysis agents and/or a liquid heating step. Column 5 provides a short process description for the process combination represented by each row entry. Column 6 shows the drying extent or range used in the dehydration step (by air or heat) for the process represented in each row. In rows E, E where a combination of air and heat drying was used the extents of dehydration by air and heat are noted. Columns 7 describes the product consistency in terms of a pumpable liquid or slurry. Columns 8/9 describe ranges of biosolids concentrations and total solids concentrations obtained as pumpable liquids in the process represented by each row. The difference between biosolids and total solids concentration in a particular product is due to added lime.

Further embodiments include the product and procedure wherein:

at least part of the first step is carried out under vacuum, and,

the first step consists of a non-heat or unheated drying step followed by a heated drying step. In this case the unheated drying may be carried out by air drying at ambient temperature and pressure, dehumidication, and drying with only slightly heated sources. and

any alkali is sufficient to maintain the mixture at a pH of greater than 11, 11.5 and/or 12 during the thermal treatment first step. and

where the alkali dose rate is greater than 20 Kg time (CaO) and/or preferably 30-40 Kg per Metric Ton biosolids having a solids concentration of 24% W/W. and

the alkali does rate for treatment of biosolids cake is proportional to cake solids concentration. and

sources of alkalis and other than lime are used at dose rates based on their OH equivalence to time. and

the first drying step is replaced by acquisition of previously dried biosolids products and pellets. This dried material is processed in steps (b) and (c). and

a preservative other than alkali is added to the product to inhibit microbial growth at any one or more of;

(1) first step drying,

(2) second re-hydration step

(3) after re-hydration.

The scope of the present disclosure is by way of example rather than by way of limitation, and the subject disclosure does not preclude inclusion of such modifications, variations, and/or additions to the present subject matter as would be readily apparent to a person skilled in the art.

We claim:

1. An industrial procedure for improving pumpability of a mass of solid high solids biosolids cake including an initial biosolids component content greater than 18% w/w and limited free water, as an organic liquid fertilizer, comprising:
(a) firstly, increasing the biosolids content of the mass by more than 5% w/w from the initial biosolids content by partially drying the biosolids component to a resultant dried biosolids content,
(a) secondly, re-hydrating the mass by mixing a quantity of process water into the mass to produce a re-hydrated mass with a biosolids content of greater than 18% w/w, and then,
(b) evaluating the viscosity of the mass as pumpable.

2. An industrial procedure for improving pumpability of a mass of solid high solids biosolids case as claimed in claim 1 wherein the procedure is carried out at ambient pressure.

3. An industrial procedure for improving pumpability of a mass of solid high solids biosolids cake as claimed in claim 1 wherein the procedure does not include aggressive shearing of the mass.

4. (canceled)

5. An industrial procedure for improving pumpability of a mass of solid high solids biosolids cake as claimed in claim 1, wherein the procedure alters the character of the biosolids component substantially only by drying.

6. An industrial procedure for improving pumpability of a mass of solid high solids biosolids cake as claimed in claim 1 wherein the biosolids content of the mass is increased to 24-25% w/w in the first step and the re-hydration step produces a re-hydrated mass with a biosolids component content of 18% w/w or more.

7. An industrial procedure for improving pumpability of a mass of solid high solids biosolids cake as claimed in claim 1 wherein the biosolids content of the mass is increased to 25-30% in the first step and the re-hydration step produces a re-hydrated mass with a biosolids component content of 18% or more.

8. An industrial procedure for improving pumpability of a mass of solid high solids biosolids cake as claimed in claim 1 wherein the biosolids component of the mass is increased to more than 30% and less than 80% in the first step while remaining sticky and the re-hydration step produces a re-hydrated mass 18% or more.

9. An industrial procedure for improving pumpability of a mass of solid high solids biosolids cake as claimed in claim 1 wherein the biosolids component content of the mass is more than 80% in non-sticky hard pellet form after the first step, including a step of grinding the pellets, along with mixing and evaluating.

10. An industrial procedure for improving pumpability of a mass of solid high solids biosolids cake as claimed in claim 5 wherein the initial biosolids content of the mass is between 22-30% biosolids w/w and the resultant mass includes a biosolids component content of one of:
(a) 35% or more,
(b) 35-37%,
(c) 40% or more,
(d) 45% or more,
(e) 50% or more,
(f) 60% or more, or
(g) 70% or more.

11. An industrial procedure for improving pumpability of a mass of solid high solids biosolids cake as claimed in claim 10 wherein the resultant mass is re-hydrated to a biosolids component content of:
(a) 20%,
(b) 22.5%,
(c) 24%,
(d) 25%,
(e) 26% or
(f) 30%
while mixing in the process water.

12. An industrial procedure for improving pumpability of a mass of solid high solids biosolids cake as claimed in claim 11 wherein the procedure includes the further steps of mixing in supplemental process water while retaining the biosolids content above 20% w/w and re-evaluating the viscosity of the mass as pumpable.

13. An industrial procedure for improving pumpability of a mass of solid high solids biosolids cake as claimed in claim 1 wherein the initial biosolids content of the mass is between 24-25.6% biosolids w/w and the resultant dried mass includes a biosolids component of 35-37%.

14. An industrial procedure for improving pumpability of a mass of solid high solids biosolids cake as claimed in claim 1 wherein the drying is carried out at an elevated temperature below 100 degrees Celsius.

15. An industrial procedure for improving pumpability of a mass of solid high solids biosolids cake as claimed in claim 1 wherein the drying is carried out at an elevated temperature provided by a heat source of either:
(a) less than 100 degrees Celsius, or
(b) between 100 and 200 degrees Celsius.

16. (canceled)

17. (canceled)

18. (canceled)

19. (canceled)

20. (canceled)

21. An industrial procedure for improving pumpability of a mass of solid high solids biosolids cake as claimed in claim 1 wherein either:
(a) the re-hydration step includes the addition of a hydrolizing agent, and/or
(b) an extended period of further thermal incubation following completion of the mixing step.

22. An industrial procedure for improving pumpability of a mass of solid high solids biosolids cake as claimed in claim 21 wherein the hydrolizing agent is lime.

23. An industrial procedure for improving pumpability of a mass of solid high solids biosolids cake as claimed in claim 21 wherein the hydrolizing agent comprises less than 4% of the total solids in the re-hydrated mass, w/w.

24. An industrial procedure for improving pumpability of a mass of solid high solids biosolids cake as claimed in claim 18 wherein the extended period is more than 2.5 hours at a temperature greater than 90 degrees Celsius.

25. (canceled)

26. An industrial procedure for improving pumpability of a mass of solid high solids biosolids cake, including a biosolids component of greater than 10% w/w and limited free water, as an organic liquid fertilizer, comprising:
(a) firstly, reducing the free water component by de-watering the mass to a biosolids component of 18% w/w or more, and
(b) secondly, increasing the biosolids content of (in description defined as drying, evaporation or desiccation) the mass by more than 5% w/w by partially drying the biosolids component,
(c) thirdly, re-hydrating the mass by mixing a quantity of process water back into the mass to produce a re-hydrated mass with a biosolids component of greater than 18% w/w, and then,
(d) evaluating (defined term in the description, broad) the viscosity of the mass as pumpable.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. An industrial procedure for improving pumpability of a mass of solid high solids biosolids cake as claimed in claim 21 where the alkali dose rate for treatment of biosolids cake is proportional to cake solids concentration.

40. (canceled)

41. (canceled)

42. (canceled)

43. A method of making a mass of dried biosolids products pumpable, the method comprising:
(a) re-hydrating the mass by mixing a quantity of process water into the mass to produce a re-hydrated mass with a biosolids content of greater than 18% w/w; and
(b) evaluating the viscosity of the re-hydrated mass as pumpable.
